(19) United States
(12) Patent Application Publication
(10) Pub. No.: US 2012/0327091 A1
(43) Pub. Date: Dec. 27, 2012

(54) Gestural Messages in Social Phonebook

(75) Inventors: Antti Eronen, Tampere (FI); Juha Ojanperä, Nokia (FI); Sujeet Mate, Tampere (FI); Igor Curico, Tampere (FI); Ole Kirkeby, Espoo (FI)

(73) Assignee: NOKIA CORPORATION, Espoo (FI)

(21) Appl. No.: 13/582,923

(22) PCT Filed: Mar. 8, 2010
(86) PCT No.: PCT/FI10/50173

§ 371 Date: Sep. 5, 2012

(51) Int. Cl. G06T 13/00

(52) U.S. Cl. 345/473

(57) ABSTRACT

A method and a system is offered to enable communicating a status of a user (320, 322, 324) to another user. The system uses avatars (350, 352, 354) to display status information, and the avatar moves (350, 354) according to a gesture recorded by the sending user. The recording of the gesture may be done e.g. with the help of motion sensors.

### BACKGROUND

The development of mobile communication networks and end-user terminals for the same has enabled people to stay in touch with each other practically regardless of time and place. New forms of communication have also arisen: instant messaging and various web-based services make it possible for people to share their news with each other. At the same time, however, personal contacts between people may become more superficial, as there is less real-world interaction between people. A person may be able to track the coordinates of his or her friends, and see without delay what messages the friends are sharing on-line. It may be more difficult, however, to keep track of the emotions and personal status of the friends with the current systems of messaging and web-based services.

There is, therefore a need for improved methods of communication for allowing people to share their status with others and for methods for increasing the feeling of being connected between people without being in the same physical space.

### SUMMARY

Now there has been invented an improved method and technical equipment implementing the method, by which the above problems are alleviated. Various aspects of the invention include a method, an apparatus, a server, a client and a computer readable medium comprising a computer program stored therein, which are characterized by what is stated in the independent claims. Various embodiments of the invention are disclosed in the dependent claims.

A method and a system is offered to enable communicating a status of a user to another user. The system uses avatars to display status information, and the avatar moves according to a gesture recorded by the sending user. The recording of the gesture may be done e.g. with the help of motion sensors.

According to a first aspect, there is provided a method for rendering an avatar, comprising electronically recording a gesture of a first user for rendering to a second user, automatically comparing at least one condition to a status of at least one of the first user and the second user, and electronically rendering an avatar to the second user based on the comparing and using the recorded gesture. According to an embodiment, the method further comprises electronically associating at least part of the recorded gesture with an avatar, wherein the avatar is associated with the first user. According to an embodiment, the method further comprises rendering the avatar in an application, such as a social phonebook application, in response to the second user viewing information of the first user with the application. According to an embodiment, the method further comprises defining the second user as a target for viewing the avatar, and defining the at least one condition related to a status of the first user. According to an embodiment, the method further comprises modifying the recorded gesture based on a user input, and determining an appearance of the avatar based on a user input. According to an embodiment, the method further comprises recording the gesture using at least one of the group of a motion sensor and a camera.

According to a second aspect, there is provided a method for forming an avatar, comprising electronically recording a gesture of a first user for rendering to a second user, electronically associating at least part of the recorded gesture with an avatar, wherein the avatar is associated with the first user, electronically defining a second user as a target for viewing the avatar, and defining at least one condition related to a status of at least one of the first user and the second user for rendering an avatar. According to an embodiment, the method further comprises modifying the recorded gesture based on a user input, and determining an appearance of the avatar based on a user input. According to an embodiment, the method further comprises recording the gesture using at least one of the group of a motion sensor and a camera.

According to a third aspect, there is provided a method for forming an avatar, comprising electronically receiving a gesture of a first user, electronically associating at least part of the recorded gesture with an avatar, wherein the avatar is associated with the first user, and forming an animated avatar based on said associating. According to an embodiment, the method further comprises electronically defining a second user as a target for viewing the avatar, and sending data of the animated avatar to a device for rendering the animated avatar to the second user. According to an embodiment, the method further comprises receiving at least one condition related to a status of the first user for rendering an avatar, comparing the at least one condition to a status of the first user, and sending the data of the animated avatar based on the comparing.

According to a fourth aspect, there is provided a method for rendering an avatar, comprising electronically receiving a gesture of a first user for rendering to a second user, automatically comparing at least one condition to a status of at least one of the first user and the second user, and electronically rendering an avatar to the second user based on the comparing and using the recorded gesture. According to an embodiment, the method further comprises receiving the at least one condition related to a status of the first user for rendering an avatar. According to an embodiment, the method further comprises rendering the avatar in an application, such as a social phonebook application, in response to the second user viewing information of the first user with the application.

According to a fifth aspect, there is provided a system comprising at least one processor, memory including computer program code, the memory and the computer program code configured to, with the at least one processor, cause the system to record a gesture of a first user for rendering to a second user, compare at least one condition to a status of at least one of the first user and the second user, and render an avatar to the second user based on the comparing and using the recorded gesture. According to an embodiment, the system further comprises computer program code configured to, with the at least one processor, cause the system to associate at least part of the recorded gesture with an avatar, wherein the avatar is associated with the first user. According to an embodiment, the system further comprises computer program code configured to, with the at least one processor, cause the system to render the avatar in an application, such as a social phonebook application, in response to the second user viewing information of the first user with the application. According to an embodiment, the system further comprises computer program code configured to, with the at least one processor, cause the system to define the second user as a target for viewing the avatar, and define the at least one condition related to a status of the first user. According to an embodiment, the system further comprises computer program code configured to, with the at least one processor, cause the system to modify the recorded gesture based on a user input, and determine an appearance of the avatar based on a user input. According to an embodiment, the system further comprises computer program code configured to, with the at least one processor, cause the system to record the gesture using at least one of the group of a motion sensor and a camera.

According to a sixth aspect, there is provided an apparatus comprising a processor, memory including computer program code, the memory and the computer program code configured to, with the processor, cause the apparatus to record a gesture of a first user, associate at least part of the recorded gesture with an avatar, wherein the avatar is associated with the first user, define a second user as a target for viewing the avatar, and define at least one condition related to a status of at least one of the first user and the second user for rendering an avatar. According to an embodiment, the apparatus further comprises computer program code configured to, with the at least one processor, cause the apparatus to modify the recorded gesture based on a user input, and determine an appearance of the avatar based on a user input. According to an embodiment, the apparatus further comprises computer program code configured to, with the at least one processor, cause the apparatus to record the gesture using at least one of the group of a motion sensor and a camera.

According to a seventh aspect, there is provided an apparatus comprising a processor, memory including computer program code, the memory and the computer program code configured to, with the processor, cause the apparatus to receive a gesture of a first user, associate at least part of the recorded gesture with an avatar, wherein the avatar is associated with the first user, and form an animated avatar based on said associating. According to an embodiment, the apparatus further comprises computer program code configured to, with the at least one processor, cause the apparatus to define a second user as a target for viewing the avatar, and send data of the animated avatar to a device for rendering the animated avatar to the second user. According to an embodiment, the apparatus further comprises computer program code configured to, with the at least one processor, cause the apparatus to receive at least one condition related to a status of the first user for rendering an avatar, compare the at least one condition to a status of the first user, and send the data of the animated avatar based on the comparing.

According to an eighth aspect, there is provided an apparatus comprising a processor, a display, memory including computer program code, the memory and the computer program code configured to, with the processor, cause the apparatus to receive a gesture of a first user for rendering to a second user, compare at least one condition to a status of at least one of the first user and the second user, and render an avatar to the second user with the display based on the comparing and using the recorded gesture. According to an embodiment, the apparatus further comprises computer program code configured to, with the at least one processor, cause the apparatus to receive the at least one condition related to a status of the first user for rendering an avatar. According to an embodiment, the apparatus further comprises computer program code configured to, with the at least one processor, cause the apparatus to render the avatar in an application, such as a social phonebook application, in response to the second user viewing information of the first user with the application.

According to a ninth aspect, there is provided an apparatus comprising means for recording a gesture of a first user, means for associating at least part of the recorded gesture with an avatar, wherein the avatar is associated with the first user, means for defining a second user as a target for viewing the avatar, and means for defining at least one condition related to a status of at least one of the first user and the second user for rendering an avatar.

According to a tenth aspect, there is provided an apparatus comprising means for receiving a gesture of a first user, means for comparing at least one condition to a status of at least one of the first user and a second user, and means for rendering an avatar to the second user with the display based on the comparing and using the recorded gesture.

According to an eleventh aspect, there is provided a computer program product stored on a computer readable medium and executable in a data processing device, the computer program product comprising a computer program code section for recording a gesture of a first user, a computer program code section for associating at least part of the recorded gesture with an avatar, wherein the avatar is associated with the first user, a computer program code section for defining a second user as a target for viewing the avatar, and a computer program code section for defining at least one condition related to a status of at least one of the first user and the second user for rendering an avatar.

According to an twelfth aspect, there is provided a computer program product stored on a computer readable medium and executable in a data processing device, the computer program product comprising a computer program code section for receiving a gesture of a first user, a computer program code section for comparing at least one condition to a status of at least one of the first user and a second user, and a computer program code section for rendering an avatar to the second user with the display based on the comparing and using the recorded gesture.

### DESCRIPTION OF THE DRAWINGS

In the following, various embodiments of the invention will be described in more detail with reference to the appended drawings, in which

FIG. 1 shows a method for displaying a recorded gesture using an avatar;

FIGS. 2a and 2b shows a system and devices for recording, sending, receiving and rendering a gesture and an avatar;

FIG. 3 shows a phonebook with avatars and gestures for indicating status of a user;

FIG. 4 shows a method for defining and recording a gesture associated with a condition;

FIG. 5 shows a method for forming an avatar with a gesture for use in a terminal;

FIG. 6 shows a method for showing an avatar with a gesture based on a condition;

FIGS. 7a and 7b illustrate recording a gesture using a motion sensor of a device;

FIG. 7c illustrates recording a gesture using an auxiliary motion sensor; and

FIG. 7d illustrates recording a gesture using a camera.

### DESCRIPTION OF THE EXAMPLE EMBODIMENTS

In the following, several embodiments of the invention will be described in the context of sharing a presence e.g. through a social phonebook. It is to be noted, however, that the invention is not limited to sharing a presence or to a social phonebook. In fact, the different embodiments may have applications in any environment where communicating activity of a person is required.

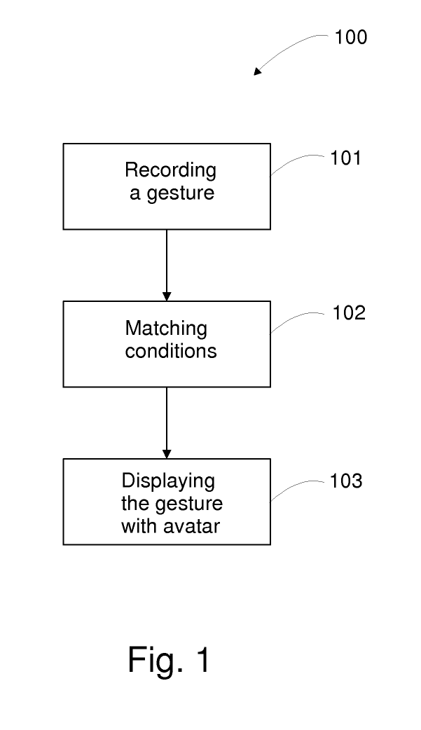

FIG. 1 shows a method for displaying a recorded gesture using an avatar. In the method 100, a gesture is recorded in phase 101. The recording of a gesture may happen in a variety of ways, such as using a motion sensor or a camera either embedded in a user device or as separate devices. The gesture is recorded as data that can be later used for example for editing and/or for rendering the gesture via a display. In phase 102, conditions for one or more users may be evaluated. For example, the status of a remote user may be obtained and compared to a group of statuses stored on a device. If a match between the status of the remote user and at least one status of the group stored in the device is found, a gesture recorded in phase 101 may be displayed in phase 103. The displaying may happen by applying the recorded gesture to an avatar, that is, by animating a graphical figure according to the gesture. This way, the movement recorded in phase 101 may be displayed in phase 103 e.g. without sending a picture or video of the remote user and even without having an end-to-end connection between the remote user's device and the device of the user viewing the avatar.

The method in FIG. 1 may comprise additional elements or be altered in some way, as described later in this description. The method may e.g.

comprise selecting at least one contact for which the avatar is displayed, selecting a graphical representation or an avatar, recording at least one sequence of gestures, creating an animation of the graphical representation showing the recorded gesture, defining a condition under which the recorded gesture is shown to the at least one contact (user of a device), and when the condition is fulfilled, showing the animation to the contact.

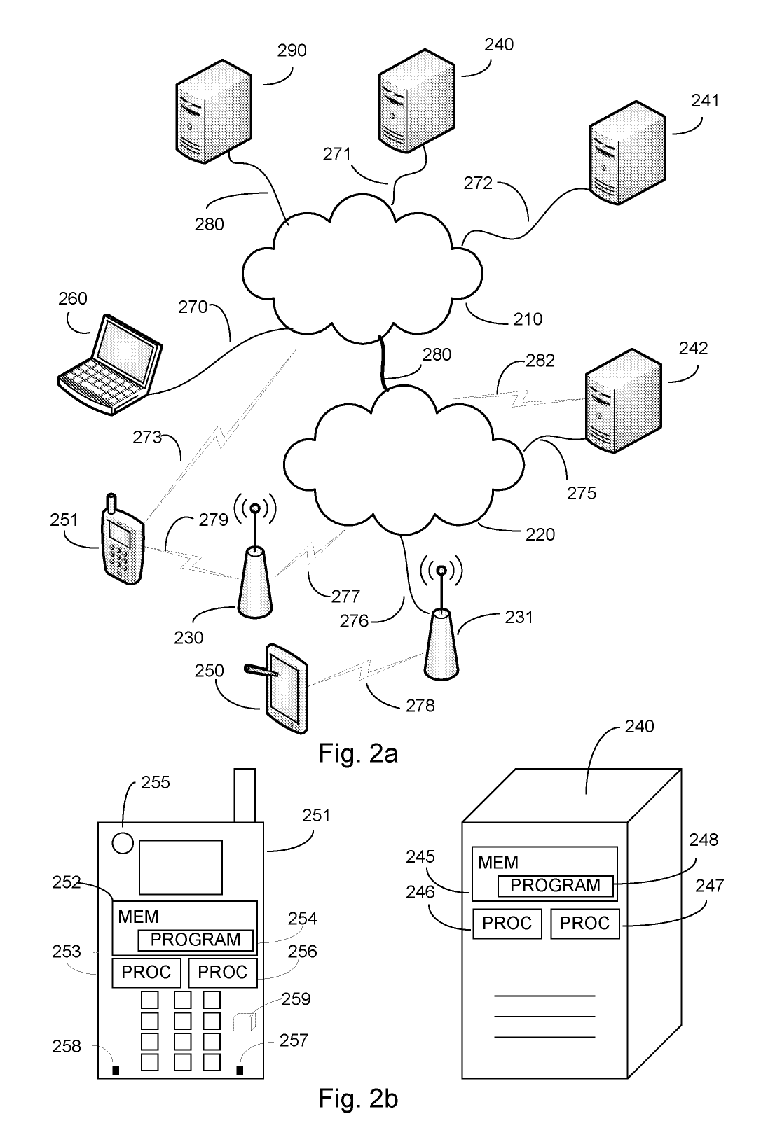

FIG. 2a shows a system and devices for recording, sending, receiving and rendering a gesture and an avatar according to an example embodiment. The different devices are connected via a fixed network 210 such as the Internet or a local area network; or a mobile communication network 220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks are connected to each other by means of a communication interface 280. The networks comprise network elements such as routers and switches to handle data (not shown), and communication interfaces such as the base stations 230 and 231 in order for providing access for the different devices to the network, and the base stations 230, 231 are themselves connected to the mobile network 220 via a fixed connection 276 or a wireless connection 277.

There are a number of servers connected to the network, and here are shown a server 240 for storing and providing avatar information and/or status information and connected to the fixed network 210, a server 241 for providing information to a social phone book and connected to the fixed network 210 and a server 242 for providing information to a social phone book and connected to the mobile network 220. There are also a number of computing devices 290 connected to the networks 210 and/or 220 that are there for storing data and providing access to the data via, for example, a web server interface or data storage interface or such, and for providing access to other devices. Some of the above devices, for example the computers 240, 241, 242, 290 may be such that they make up the Internet with the communication elements residing in the fixed network 210.

There are also a number of end-user devices such as mobile phones and smart phones 251, Internet access devices (Internet tablets) 250 and personal computers 260 of various sizes and formats. These devices 250, 251 and 260 can also be made of multiple parts. The various devices are connected to the networks 210 and 220 via communication connections such as a fixed connection 270, 271, 272 and 280 to the internet, a wireless connection 273 to the internet 210, a fixed connection 275 to the mobile network 220, and a wireless connection 278, 279 and 282 to the mobile network 220. The connections 271-282 are implemented by means of communication interfaces at the respective ends of the communication connection.

FIG. 2b shows devices for recording gestures, operating a social phone book and for comparing conditions and displaying an avatar according to an example embodiment. As shown in FIG. 2b, the server 240 contains memory 245, one or more processors 246, 247, and computer program code 248 residing in the memory 245 for implementing, for example, social phone book functionality or presence functionality storing status information. The different servers 241, 242, 290 may contain at least these same elements for employing functionality relevant to each server. Similarly, the end-user device 251 contains memory 252, at least one processor 253 and 256, and computer program code 254 residing in the memory 252 for implementing, for example, social phone book functionality or presence functionality, or for recording a gesture. The end-user device may also have at least one camera 255 for taking pictures. The end-user device may also contain one, two or more microphones 257 and 258 for capturing sound. The end-user device may also comprise at least one motion sensor 259 for recording movement and orientation of the device. The different end-user devices 250, 260 may contain at least these same elements for employing functionality relevant to each device. Some end-user devices may be equipped with a digital camera enabling taking digital pictures, and one or more microphones enabling audio recording during, before, or after taking a picture. Some end-user devices may comprise a plurality of motion sensors of the same kind, or different kinds of motion sensors.

It needs to be understood that different embodiments allow different parts to be carried out in different elements. For example, the forming of the avatar may be carried out entirely in one user device like 250, 251 or 260, or the forming of the avatar may be entirely carried out in one server device 240, 241, 242 or 290, or the forming of the avatar may be carried out across multiple user devices 250, 251, 260 or across multiple network devices 240, 241, 242, 290, or across user devices 250, 251, 260 and network devices 240, 241, 242, 290. The forming of the avatar can be implemented as a software component residing on one device or distributed across several devices, as mentioned above, for example so that the devices form a so-called cloud. The forming of the avatar may also be a service where the user accesses the forming of the avatar service through an interface, for example, using a browser. In a similar manner, the recording of the gesture, matching the conditions and displaying the avatar may be implemented with the various devices in the system.

The different embodiments may be implemented as software running on mobile devices and optionally on services. The mobile phones may be equipped at least with a memory, processor, display, keypad, motion detector hardware, and communication means such as 2G, 3G, WLAN, or other. The motion detector may for example measure six attributes, such as acceleration in three orthogonal directions and orientation in three dimensions such as yaw, roll, and pitch. For detecting acceleration, micro-electro-mechanical systems (MEMS) accelerometers may be used, for example, since they are small and lightweight.

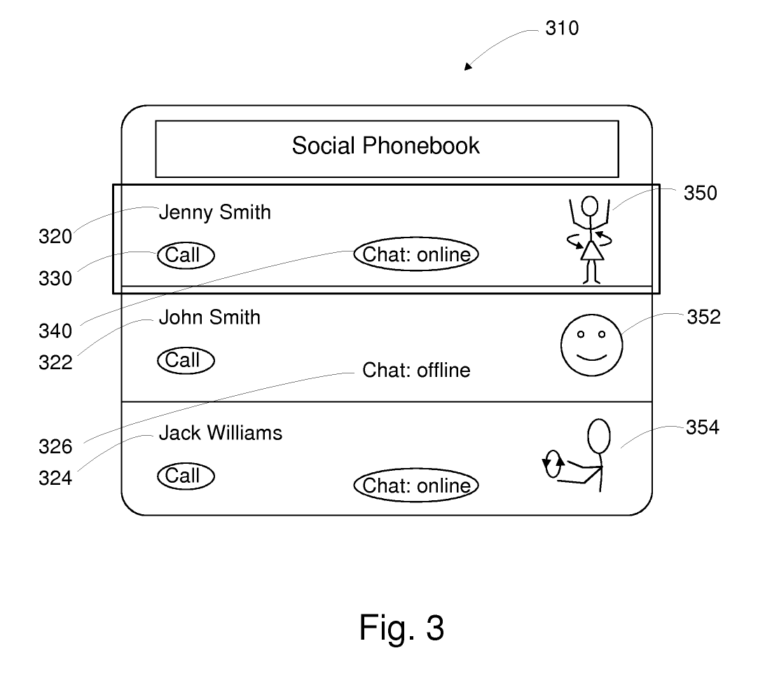

FIG. 3 shows a social phonebook with avatars and gestures for indicating status of a user. A social phonebook application 310 may contain information on users such as their names and images. A user may browse another user from the phonebook, and start communication with him. In addition, the phonebook may show status and availability information for the users. According to an embodiment, the social phonebook may also allow recording a gesture and associating the gesture with an avatar, contact and condition, and visualizing a gesture with the help of an avatar when a condition is met for a contact in the phonebook or the user of the device.

In FIG. 3, a schematic user interface of the social phonebook application 310 is shown. User has activated the information of the contact Jenny Smith 320. Jenny Smith has defined a gesture 350 of raising hands in the air and dancing for her current situation (e.g. having a break at the office), and this is now shown to the user. The second contact John Smith 322 has not defined any gestures and his usual images or status indicator 352 is shown. Jack Williams 324 has defined a gesture 354 relating to driving a car, and since he is currently driving a car, the gesture is shown to the user. The phonebook may contain active elements 330 for calling a contact. The phonebook may also indicate the presence of the contact in an instant messaging (chat) application with an element 326 (off-line) and 340 (on-line) that may be used to initiate a discussion with the contact.

The social phonebook application contains information on users such as their names, images, phone numbers, email addresses, postal addresses, and links to their accounts in different messaging services such as chat or internet call. In addition, the social phonebook may show status or availability information for the user (such as “in a meeting”). The social phonebook may be used to search for a contact and then start a communication session with him. The availability info helps to decide which communication medium to use or whether to start the communication at all. In the present embodiment the social phonebook is modified such that the phonebook allows recording a gesture and associating it with a character, contact and condition. The gesture may then be visualized by another user in his/her social phonebook when the condition is met for the contact. In another embodiment, the gesture recording and animation recording may be carried out in another application, and the social phonebook allows associating a graphical sequence with a contact and condition.

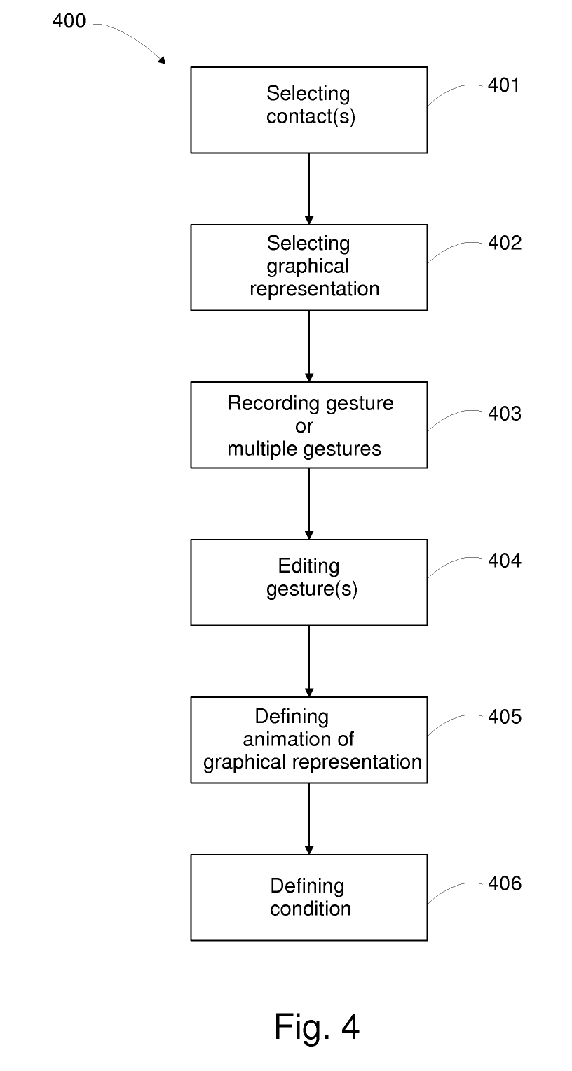

FIG. 4 shows a method 400 for defining and recording a gesture associated with a condition. According to an embodiment, a physical gesture such as hand waving may be recorded and stored for later display in a social phonebook. More specifically, user A first selects at least one contact B from the phonebook in phase 401. Then user A selects a graphical representation such as an avatar in phase 402. He then holds the phone e.g. in his hand and records a gesture, such as hand waving in phase 403. The recorded gesture may be modified in phase 404 e.g. by clicking or drawing and/or automatic modification of the recorded gesture such as smoothing or changing the speed. The recorded gesture is then attached to a graphical representation (an avatar) in phase 405. Next, the user determines or selects a condition under which the gesture is shown to the selected contacts in phase 406. When the selected contact B then views user A′s information in the phonebook and the condition is met, the gestural message is shown to user B. For example, user A may define that whenever one of his friends views his phonebook info, a hand-waving gesture is shown to them with the help of an avatar. The avatar may be modified according to contextual (e.g. location) information and the gestures may be displayed also during a communication session. Note that the order of the above steps is shown as an example and may be changed. In addition, some steps, for example 404 editing a gesture, may be omitted.

For creating a gesture animation, a user may first start the social phonebook application. He may select a set of one or more contacts from a list of contacts displayed by the application, or he may select a contact group. The user may then select a graphical representation such as an avatar e.g. from a list or a graphical display of different avatars. The user may then proceed to select the option record a gesture. Optionally, at this stage the user may select the phone location from a set of alternatives indicating where the device is being held. The alternatives may include e.g. “left hand”, “right hand”, “left hip”, “right hip”, “stomach”, “bottom”, “left leg” and “right leg”. If the user does not select a phone location, a default location such as right hand may be assumed.

Next, the user makes a sequence of movements, i.e. a gesture, while holding the phone in the selected location. Then he stops the recording, and can choose to render the gesture for viewing. Then, the application may show the selected avatar performing the recorded gesture sequence. The recorded movement data is mapped to gestural data at the selected bodily part. For example, if the phone location was “left hand”, the left hand of the avatar moves according to the user's recorded moves. Optionally, the user may edit the movement e.g. such that the application shows the gesture in slow motion and the user is able to edit the movement pattern e.g. by clicking and drawing on the screen, or the modification may be done automatically e.g. to make the movement smoother, faster or slower. Optionally, the user is able to record movement patterns for several bodily parts (phone locations). For example, the user may be able to record separate gestures for the left and right hands, and these will then be mapped to the movement to the left and right hand, respectively. The different gestures of the different body parts may first be synchronized with each other in time. Finally, the user may select a condition determining at which instance the animation is to be shown to the contact. The selection may be done e.g. from a list. The condition may relate to the situation of the user himself or of the contact who is viewing the social phonebook, or both.

To perform the above method according to an embodiment, the following software and/or hardware modules may exist in a device or multiple devices. A gesture recording module may allow the user to perform a gesture while holding the phone in his hand or otherwise attached to the body. Motion parameters such as acceleration and/or orientation and position are measured, and mapped to parameters of a 2D or 3D animation e.g. to create a motion trajectory (gesture). A database of animated characters with configurable gestures may be utilized to create the animated and moving avatars. A database of stored gestures may be used so that the recording of a gesture may not be necessary, and the gestures can be chosen and/or downloaded for use with an avatar from the database. It is also possible to use gesture recording to find the gestures that resemble a desired gesture from a database of stored gestures, and then allow the user to select one of the closest gestures as the one to be used or perform the selection automatically. The gesture and character databases may also be combined. A condition defining module, which allows defining conditions such as “I′m busy”, “I′m in a meeting”, “I′m driving a car”, “My friend is browsing my information on phonebook”, “My friend is initiating a call”, “My friend is sending an SMS message”, and so on, may be used for making it easier to define conditions for showing the gesture. A database storing associations between stored gestures, animated characters, phonebook contacts, and conditions may be used, or the association may be stored directly to the phonebook contacts or arranged in another manner. A context sensing module, which senses information on the situation of a user may be employed. For example, the context sensing module may use audio information and other sensory information to sense that the user is driving a car.

An avatar may here be understood as an articulated (jointed) object that moves according to an inputted gestural sequence. The avatar may mean an animated figure of a person, but an avatar may also be e.g. an animal or machine, or even a normally lifeless object like a building. In an embodiment, the avatar comprises two parts: a skeleton determining the pose and movement of the avatar, and a skin which specifies the visual appearance of the avatar. In other words, the skin defines the visible body generated around the moving skeleton. The avatar may also comprise three-dimensional objects joined together, without a division to a skeleton and a skin.

Gesture data may comprise structured data that specify a movement of a skeleton e.g. as a time-stamped sequence of poses. Time-stamping may be regular or variable. A pose can be defined using a gesture vector v which specifies the position in space of the avatar body parts. An ordered set of gesture vectors {v: v(1),v(2), . . . ,v(m)} that has a vector v(i) for each of the time instances i can be used to define a gesture sequence.

The rendering may then comprise receiving a pose for the current time instance i, and rendering the avatar using the skeleton and the skin.

The gesture vector v(i) may define the pose for the avatar skeleton and the skin may define the body and appearance. The skin can be rendered with standard computer graphics techniques, e.g. using a polygon mesh and textures mapped thereon.

A gesture file may contain the pose sequence data and at least a reference to suitable avatar, or avatar data itself. The avatar reference may e.g. be a hyperlink or a uniform resource identifier (URI). The mobile device of the user whose status is being viewed (the sender) may render the avatar in motion. Alternatively or in addition, when the viewing user (the receiver) views the avatar, his device may render the avatar. In some embodiments the rendered avatar may be uploaded from the sender's device to a server or to the receiver's device in some suitable graphics file format, and the receiver's device then shows the animation. In some embodiments, the gesture data is uploaded from the sender's device to a server which renders the avatar for use at the receiver's device.

The conditions for rendering a gesture may be e.g. the following: “sender busy”, “sender in a meeting”, “sender is driving a car”, “sender is on holiday”, “sender is traveling”, “recipient is browsing sender's information on phonebook”, “sender is initiating a call”, “sender is sending an SMS message”, and “recipient/sender is happy/sad/angry/puzzled”. In general, the conditions may be based on sender/receiver presence and context and/or both.

In general, the conditions may be of the form

<person><environment><activity><mood>

In the above, <person> can be either sender, receiver or both. The <environment> may comprise e.g. meeting, office, holiday, school, restaurant, pub, and home. The <activity> may include e.g. driving a car/bicycle, skateboarding, skiing, running, walking, traveling, browsing phonebook, initiating a call, and sending an SMS message. The <mood> may include for example happy/sad/angry/puzzled.

The conditions may be saved in a conditions file, or they may be stored in connection with the social phonebook, e.g. in association with the respective phonebook entries.

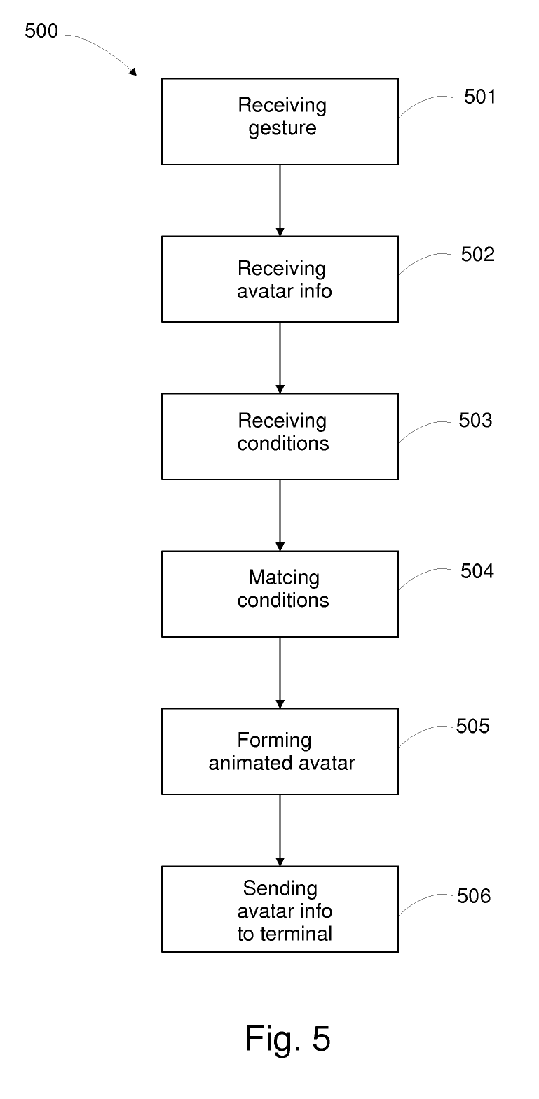

FIG. 5 shows a method 500 for forming an avatar with a gesture for use in a terminal. The method 500 may be performed at least partially or in whole at a server. In phase 501, a gesture may be received e.g. by means of a communication connection from a user device such as a mobile terminal and/or a sensor. The gesture may be gesture data or it may be a link to gesture data. In phase 502, information on an avatar may be received from a user, e.g. by means of a communication connection, or by offering the user a web interface where an avatar may be selected. The avatar information may be information and data on the skeleton and/or the skin of an avatar, or it may be a link to such information and data, or both.

In phase 503, conditions may be received from the sender and/or from the receiver. That is, the sender and/or receiver may define conditions when a gesture and/or an avatar are shown to the viewing user. These conditions may be received over a communication connection or they may be received as an input from a user e.g. through a web interface. In phase 504, the received conditions may be matched with the present status of the sender and/or receiver to determine which gesture and/or which avatar to display to the receiver. In phase 505, an animated avatar may be formed, e.g. by linking gesture data to the avatar data.

The data may be rendered as a series of images, or the gesture data and avatar data may be used as such. In phase 506, information on the avatar and the gesture may be sent to the receiver terminal. This information may be a link to avatar data and/or to gesture data at the server or at another device or at the receiver device. This information may also be avatar and gesture data as such, or it may be a rendered avatar.

The operation described above may be part of an operation of a social phonebook implemented on a network server, or the above operation may be a standalone application for implementing the avatar and gesture functionality on a server.

The gesture data may be stored at the device where the gesture was recorded, at a server or at the device of the other user who then views the gesture based on conditions. Similarly, the avatar data may be stored at the device where the gesture was recorded, at a server or at the device of the other user who then views the avatar. The gesture and the avatar may both be stored on the creating user's device. There may be a set of avatars that come with the Social Phonebook application. For example, when the gesture needs to be shown to user viewing user, the gestural data is sent to the viewing user's terminal, and is then used to render the movement using the avatar stored on the viewing user's terminal.

The avatars and/or gestures may also be stored on a server, so that when a user wants to record a gesture, he may first download an avatar. The recorded gesture may then be uploaded to the server. When another user then views the gesture, the gesture and avatar may be downloaded from the server to his device either at the same time or at an earlier time, or both. Alternatively, when a user is viewing the gesture, the gesture may be downloaded from a server as a video or an animation sequence instead of a combination of avatar and gesture data. The avatar may be selected by the sender (the user who records the gesture) or the receiver (the user who views the avatar). That is, the receiver may select the avatar, e.g., to override the avatar selection of the sender.

The storage and transmission of gesture data may be achieved with approximately 10 kB/s at a rate of 60 frames per second (fps), if the avatar has e.g. 15 joints with 3 dimensions per joint and 4 bytes used per dimension. The gesture data may not need to be sampled at 60 fps, and e.g. interpolation and/or some differential encoding that considers joints that do not move may be used to reduce the data rate. Avatars may be quite static, and they may be downloaded only once or very rarely, when updates are available.

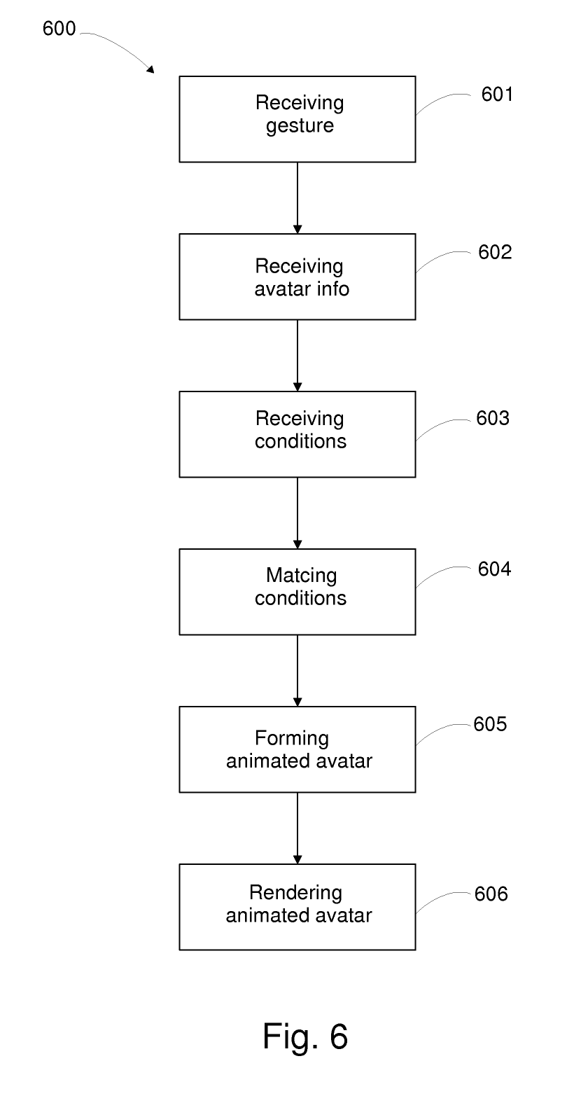

FIG. 6 shows a method 600 for showing an avatar with a gesture based on a condition. The showing of the avatar may happen e.g. on an end-user device, or the avatar may be rendered at a server and shown over a network connection. In phase 601, gesture information as gesture data or as a link to gesture data may be received. In phase 602, avatar information as avatar data or as a link to avatar data may be received. The gesture information and the avatar information may also be received together e.g. as a combined file. The data may originate from a user device or from a server, such as explained in connection with FIG. 5.

In phase 603, conditions may be received of the sender and/or from the receiver. That is, the sender and/or receiver may define conditions when a gesture and/or an avatar are shown to the viewing user. These conditions may be received over a communication connection or they may be received as an input from a user e.g. through a web interface or directly to the user device. In phase 604, the received conditions may be matched with the present status of the sender and/or receiver to determine which gesture and/or which avatar to display to the receiver. The avatar may then be rendered to the user based on the conditions, or the avatar may be rendered without using the conditions, i.e. shown regardless of the states of the users. In phase 605, an animated avatar may be formed, e.g. by linking gesture data to the avatar data. In phase 606, the avatar is rendered to the user.

In the following, the operation of the example embodiments is described with the help of practical examples. The receiver (the viewing user B) starts the social phonebook application. He selects a contact (user A) from the phonebook list. The social phonebook application checks the status of user A. If the status of user A has an associated gesture, it is shown to user B. For example, if user A is in a meeting and he has defined a gesture for the meeting situation, it is shown to user B. If there is no gesture related to the situation of user A, the application checks the situation of user B. If the status of the viewing user B has an associated gesture defined by user A, it is shown. For example, if user A has defined a gesture resembling holding a phone on the ear and linked it to the situation “My friend is initiating a call”, it is shown to user B.

For example, a user John records a gesture that resembles turning a steering wheel. He does this by holding the mobile phone in his hand and moving his hand in the air along an imagined half-circle. Then he selects contacts from a group “My friends”, selects an animated character, and selects a condition “I′m driving a car”. When one of his friends browses to John's information in the phonebook while John is driving a car, he sees the selected animated character turning a steering wheel.

As another example, a user Jim records a gesture which resembles making a kiss in the air by holding the phone in his hand. He then selects an avatar. He selects the contact “wife” from the phonebook. When his wife calls or browses Jim's info, she sees the animation of making a kiss into the air.

In an embodiment, the representation of the selected gesture(s) is modified depending on the context. The gesture representation may be modified depending on the context conditions of the person viewing the contact information in a social phonebook. For example, consider an avatar representing a dancing gesture. The avatar is made by an engineer who belongs to the “CC Software” team. When a family member of the engineer views his information, the avatar shows information “At a party with team mates” and shows a fairly professional gesture. When a colleague from the same subunit within the company views the information, an identification of the team may be added. For example, a T-shirt with the text “CC Software” may be added to the avatar, and the avatar may dance wildly. This provides additional information for those viewers for which it may be relevant: it indicates the team to the members of the subunit. If a contact who is not a colleague or a member of the family views the phonebook, the avatar may just display information “at a party” and show a regular party gesture.

In another embodiment of the invention, the animations of an avatar may be displayed and varied during a phone call or other communication. To enable this, the application may be extended so that the user is able to record different gestures and tag them with descriptive words. The gestures may be associated with e.g. feelings such as angry, puzzled, happy, amazed, sad, and so on. During a call or other communication like chat, a user may select a gesture animation from a list. The selected animation is then played at the social phonebook application of the calling party. The feelings may also be detected from the speech or typing of the user. The status of the user may also be determined from calendar information, location, time of day and physical activity such as sports.

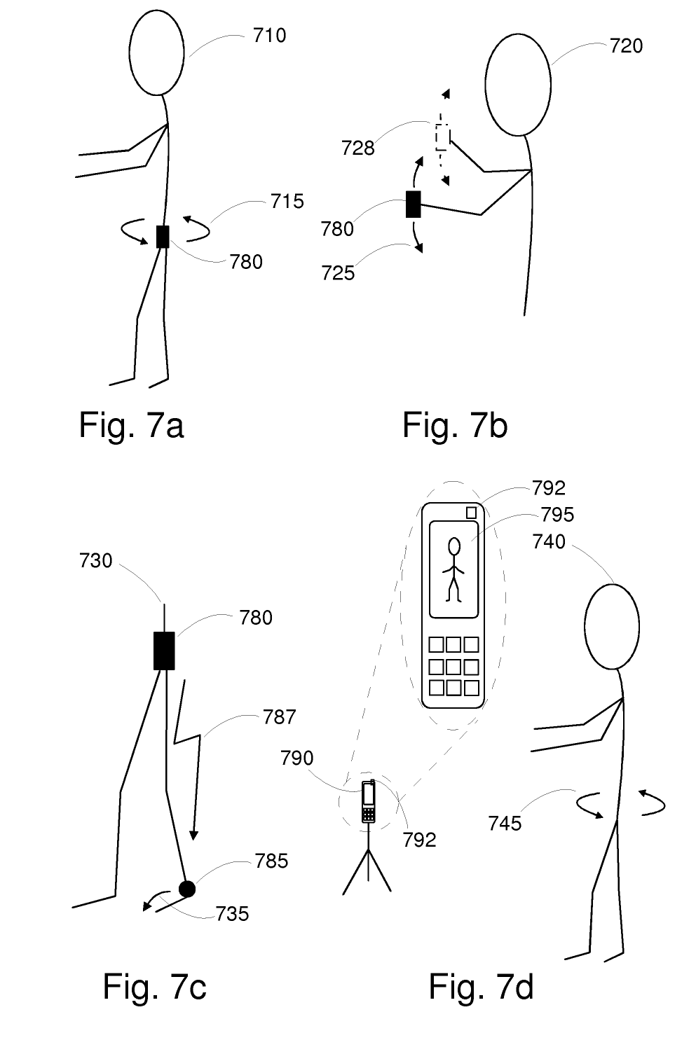

FIGS. 7a and 7b illustrate recording a gesture using a motion sensor of a device. In FIG. 7a, the user 710 holds the device 780, e.g. a mobile phone, on his waist. This can e.g. happen by holding the device 780 by hand, attaching it to the belt or keeping it in the pocket. When the user has started recording, he makes a rotating movement 715 with his waist to demonstrate dancing. The device 780 uses e.g. its internal motion sensors to detect the movement and builds gesture data from the recording. In FIG. 7b, the user 720 holds the device 780 in his left hand and makes an up-and-down movement 725 with the left hand to record a gesture. The user 720 may also switch the device to the right hand to complement the earlier recorded left hand gesture, and records an up-and-down movement 728 with the right hand.

Various different means may be used for recording the movement for a gesture. Motion sensors may be used, e.g. the built-in accelerometer in many contemporary phones may be used for this purpose. Another alternative may be to use specific motion sensor(s) attached to different body parts. This way, a gesture with a plurality of moving points could be determined at once. Various methods for motion capture may be used.

FIG. 7c illustrates recording a gesture using an auxiliary motion sensor 785. The auxiliary motion sensor 785 may be for example a foot pod, wherein the foot pod is able to detect and/or record movement and communicate the recorded movement to the main device 780. In FIG. 7c, the user 730 makes a forward movement 735, e.g. a walking movement with the foot, the auxiliary sensor 785 records the movement and transmits the movement to the main device 780 using e.g. a wireless communication connection 787. There may also be multiple auxiliary sensors so that the movement of multiple body parts may be carried out at once.

FIG. 7d illustrates recording a gesture using a camera. The device 790 may be a device like a mobile phone that has a built-in or attached camera module 792 enabling the device to capture pictures and/or video. The device may have a display 795 enabling the viewing of the captured pictures and video. The user 740 may place the device so that it faces the user, e.g. on a tripod, and thereby the user is in the field of view of the camera. The user may then start recording a motion 745, and the motion is captured by the camera. After capture, the pictures and/or the video may be processed to extract the motion to create gesture data. Additionally, the camera may be used to create an avatar, e.g. to capture a texture or a picture for use in the avatar skin.

To record a gesture, optical systems with one or more cameras may be used, which may be easily arranged since many mobile phones are equipped with a digital camera. Special markers may be attached to the actor at known positions thereby enabling estimating the poses. Mechanical motion capture involves attaching a skeletal-like structure to the body, and when the body moves also the mechanical parts move, and the movement may be captured with sensors. Magnetic systems may utilize the relative magnetic flux of three orthogonal coils on the transmitter and receivers, whereby each transmitter coil is transmitting a different signal that can be detected by the receiver coils for computation of the place and orientation of the transmitter. In some embodiments, the motion of a specific body part, such as the face, may be captured. In this case specific facial detection and motion capture methods may be used. A combination of methods, for example motion capture for full skeletal motion combined with optical sensing for facial gestures, may also be used.

The various embodiments of the invention can be implemented with the help of computer program code that resides in a memory and causes the relevant apparatuses to carry out the invention. For example, a terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1-34. (canceled)

35. A method for rendering an avatar, comprising:
electronically recording a gesture of a first user for rendering to a second user,
automatically comparing at least one condition to a status of at least one of the first user and the second user, and
electronically rendering an avatar to the second user based on the comparing and using the recorded gesture.

36. A method according to claim 35, further comprising:
electronically associating at least part of the recorded gesture with an avatar, wherein the avatar is associated with the first user.

37. A method according to claim 35, further comprising:
rendering the avatar in an application, such as a social phonebook application, in response to the second user viewing information of the first user with the application.

38. A method according to claim 35, further comprising:
defining the second user as a target for viewing the avatar, and
defining the at least one condition related to a status of the first user.

39. A method according to claim 35, further comprising:
modifying the recorded gesture based on a user input, and
determining an appearance of the avatar based on a user input.

40. A method according to claim 35, further comprising:
recording the gesture using at least one of the group of a motion sensor and a camera.

41. A method for forming an avatar, comprising:
electronically recording a gesture of a first user for rendering to a second user,
electronically associating at least part of the recorded gesture with an avatar, wherein the avatar is associated with the first user,
electronically defining a second user as a target for viewing the avatar, and
defining at least one condition related to a status of at least one of the first user and the second user for rendering an avatar.

42. A method according to claim 41, further comprising:
modifying the recorded gesture based on a user input, and
determining an appearance of the avatar based on a user input.

43. A method according to claim 41, further comprising:
recording the gesture using at least one of the group of a motion sensor and a camera.

44. An apparatus comprising a processor, memory including computer program code, the memory and the computer program code configured to, with the processor, cause the apparatus to perform at least the following:
record a gesture of a first user,
associate at least part of the recorded gesture with an avatar, wherein the avatar is associated with the first user,
define a second user as a target for viewing the avatar, and
define at least one condition related to a status of at least one of the first user and the second user for rendering an avatar.

45. An apparatus according to claim 44, further comprising computer program code configured to, with the processor, cause the apparatus to perform at least the following:
modify the recorded gesture based on a user input, and
determine an appearance of the avatar based on a user input.

46. An apparatus according to claim 44, further comprising at least one of the group of a motion sensor and a camera, and computer program code configured to, with the processor, cause the apparatus to perform at least the following:
record the gesture using at least one of the group of a motion sensor and a camera.

47. An apparatus comprising a processor, memory including computer program code, the memory and the computer program code configured to, with the processor, cause the apparatus to perform at least the following:
receive a gesture of a first user,
associate at least part of the recorded gesture with an avatar, wherein the avatar is associated with the first user, and
form an animated avatar based on said associating.

48. An apparatus according to claim 47, further comprising computer program code configured to, with the processor, cause the apparatus to perform at least the following:
define a second user as a target for viewing the avatar, and
send data of the animated avatar to a device for rendering the animated avatar to the second user.

49. An apparatus according to claim 47, further comprising computer program code configured to, with the processor, cause the apparatus to perform at least the following:
receive at least one condition related to a status of the first user for rendering an avatar,
compare the at least one condition to a status of the first user, and
send the data of the animated avatar based on the comparing.

50. An apparatus comprising a processor, a display, memory including computer program code, the memory and the computer program code configured to, with the processor, cause the apparatus to perform at least the following:
receive a gesture of a first user for rendering to a second user,
compare at least one condition to a status of at least one of the first user and the second user, and
render an avatar to the second user with the display based on the comparing and using the recorded gesture.

51. An apparatus according to claim 50, further comprising computer program code configured to, with the processor, cause the apparatus to perform at least the following:
receive the at least one condition related to a status of the first user for rendering an avatar.

52. An apparatus according to claim 51, further comprising computer program code configured to, with the processor, cause the apparatus to perform at least the following:
render the avatar in an application, such as a social phonebook application, in response to the second user viewing information of the first user with the application.

53. A computer program product stored on a computer readable medium and executable in a data processing device, the computer program product comprising:
a computer program code section for recording a gesture of a first user,
a computer program code section for associating at least part of the recorded gesture with an avatar, wherein the avatar is associated with the first user,
a computer program code section for defining a second user as a target for viewing the avatar, and
a computer program code section for defining at least one condition related to a status of at least one of the first user and the second user for rendering an avatar.

54. A computer program product stored on a computer readable medium and executable in a data processing device, the computer program product comprising:
a computer program code section for receiving a gesture of a first user,
a computer program code section for comparing at least one condition to a status of at least one of the first user and a second user, and
a computer program code section for rendering an avatar to the second user with the display based on the comparing and using the recorded gesture.
